(19) United States
(12) Patent Application Publication
(10) Pub. No.: US 2017/0343263 A1
(43) Pub. Date: Nov. 30, 2017

(54) System and Method for Making an Ice Sculpture

(71) Applicant: Ning Liao, Lebanon, NJ (US)

(72) Inventor: Ning Liao, Lebanon, NJ (US)

(21) Appl. No.: 15/168,510

(22) Filed: May 31, 2016

(51) Int. Cl. F25C 1/12; F25C 5/14; A23G 9/22; B33Y 10/00; B33Y 30/00

(52) U.S. Cl. CPC F25C 1/12; F25C 5/14; A23G 9/22; B33Y 30/00; B33Y 10/00

(57) ABSTRACT

A system for making a three dimensional ice sculpture has a movable print head and fan mounted in a refrigerated enclosure. The print head has an inlet connected to a source of chilled water and can spray dyed or undyed water at a platform. A controller can move the print head and regulate its water outflow. A fluid can be discharged into the sprayed water at a temperature that accommodates ice formation. The sprayed water forms successive layers that freeze.

### BACKGROUND OF THE INVENTION

### 1. Field of the Invention

The present invention relates to ice sculptures, and in particular, to systems and methods using 3-D printing techniques.

### 2. Description of Related Art

Ice sculptures are often made as table decorations for dinners, banquets, parties, and other festive occasions. While these decorations can in fact be sculpted by hand from a large block of ice, in most cases a multi-part mold is filled with water that is then frozen, so that later the mold can be opened to expose the ice sculpture. Obtaining an inventory of different molds can be fairly expensive since the molds must be strong enough to support the weight of the water, and accommodating enough to deal with the expansion that occurs when water freezes.

Hand sculpting ice is even more expensive since a skilled artisan must be found and must spend a significant amount of time sculpting the details that will make the sculpture appealing.

In 3-D printing, a computer-aided design can produce files that can be converted into a corresponding file that defines the outline of a number of successive layers in the design. Thereafter a computer-controlled print head can be used to deposit successive layers of material over a platform, each layer being defined by the file derived from the computer-aided design After a specific layer is deposited, the platform can descend incrementally, creating space for the next layer.

This process is repeated until all layers have been deposited and the desired shape has been produced. Often, a 3-D printer is used to produce a prototype that gives developers a better understanding of a proposed product. In other cases, the printed item is used as a negative for creating a mold that will be used to produce manufactured goods. Today it is becoming more common to use a 3-D printer to produce a final commercial product

The material deposited by the 3-D printer can be a liquid polymeric substance that is cured and solidified by an ultraviolet light. In other cases the printer can include a heater that liquefies a thermoplastic that cools and solidifies after printing.

In some cases a designer will want a 3-D printer to produce a three dimensional shape with undercuts or overhangs; e.g. an open, upright umbrella. One cannot print the rim of an umbrella if there is no underlying support. For this reason some 3-D printers will print a support material that is different than the material used to fabricate the desired product. The support material will produce a platform for supporting overhanging features of the design. The support material can be later dissolved and discarded to produce the final product.

See also US Patent Application Publication Nos. 2004/0038009; 2013/0287933; 2014/0054817; 2014/0088751; 2014/0265034; 2014/0271964; 2014/0374935; and 2015/0231830; as well as U.S. Pat. No. 8,460,45.

### SUMMARY OF THE INVENTION

In accordance with the illustrative embodiments demonstrating features and advantages of the present invention, there is provided a system for making a three dimensional ice sculpture. The system includes an enclosure, and a movable print head mounted in the enclosure for spraying at least water. The print head has an inlet adapted to connect to a source of chilled water. Also included is a controller operable to move the print head and regulate water flow out of the print head. The system also includes a port adapted to be connected to a source of fluid for discharging fluid within the enclosure at a temperature that accommodates ice formation from water sprayed from the print head.

In accordance with another aspect of the invention, there is provided a system for making a three dimensional ice sculpture. The system includes a refrigerated enclosure, and a movable print head mounted in the enclosure for spraying at least water. The print head has an inlet The system also includes a controller operable to move the print head and regulate water flow out of the print head. Also included is a duct mounted on the print head The duct is adapted to be connected to a source of fluid and oriented to direct fluid flow into water sprayed from the print head. Also included is a fan inside the enclosure.

The system also includes a vertically movable platform mounted inside the enclosure. The controller is coupled to the platform and is operable to control its descent. The controller is operable to move the print head in two dimensions over the platform. The system also includes a manifold adapted to receive chilled water and one or more dyes. The manifold is coupled to the inlet of the print head to deliver a mixture of chilled water and the one or more dyes.

In accordance with yet another aspect of the invention a method is provided for making a three dimensional ice sculpture. The method employs a platform inside an enclosure. The method includes the step of initially spraying at least water at a time-varying location above the platform to form a base layer that is allowed to freeze. Another step is subsequently spraying at least water at a time-varying location above the base layer to form a succeeding layer that is allowed to freeze.

By employing systems and methods of the foregoing type, an improved technique is provided for making ice sculptures. In a disclosed embodiment, a movable print head is mounted inside a refrigerated enclosure above a vertically movable platform. The print head can be supported on a gantry that allows horizontal movement in two dimensions. For example, the print head can be slidably mounted (to slide in the x direction) on a bar whose opposite ends can transversely slide (slide in the y direction) along a parallel pair of rails.

In a disclosed embodiment, successive layers of water are deposited over the platform, which descends incrementally to allow room for the next layer. The water is deposited at a temperature close to freezing (in some cases the water is supercooled). The freezing can be bolstered by directing a flow of frigid air into the water being sprayed from the print head. In some cases a liquefied gas that is discharged onto the deposited water, will become gaseous and quickly freeze the water.

In another embodiment the platform supporting the growing ice sculpture will not move, and instead a multi-jointed, articulated arm can move the print head in three dimensions to develop the ice sculpture with a high degree of flexibility.

In one disclosed embodiment, chilled water is mixed in a manifold with dyes before being sprayed from the print head. A controller can vary the amount of dye to produce a variety of colors, including no color (clear and neutral). In still other embodiments a fluent, fibrous material can be mixed with the chilled water in a manifold before being sprayed by the print head. This fibrous material increases the strength of the resulting sculpture, allowing extreme shapes not feasible in ordinary ice sculptures.

One disclosed embodiment starts each layer by first depositing frozen ice particles These ice particles can be produced by a snow-making machine or by vacuuming natural snow from a snow-filled container. This deposited layer of frozen ice particles is then leveled and smoothed by a mechanical spreader that establishes a desired depth. The spreader can be a pivoted wiper blade or a blade that traverses much like a screed. Thereafter, water sprayed onto pre-programmed regions of the layer of ice particles will freeze.

Accordingly, multiple layers of ice will be formed surrounded by layers of ice particles that are relatively loose. When the three-dimensional sculpture is finished, an operator can remove the loose ice particles to reveal the finished ice sculpture. These loose ice particles can operate as a support material that allows formation of a sculpture with overhangs, undercuts, etc

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view, with portions broken away for illustrative purposes, of a system for performing a method in accordance with principles of the present invention;

FIG. 2 is a cross-sectional view of the print head of FIG. 1, together with a schematic diagram of a controller and manifold cooperating with the print head;

FIG. 3 is a sectional view of a dispensing unit that can be used with the system of FIG. 1;

FIG. 4 is a plan view of two of the units of FIG. 3 installed in the system of FIG. 1;

FIG. 5 is an elevational view of the system of FIG. 4, shown after a substantial portion of an ice sculpture has been fabricated;

FIG. 6 is a plan view of an arrangement that is an alternate to that of FIG. 4;

FIG. 7 is an elevational view of the system of FIG. 6, shown after a substantial portion of an ice sculpture has been fabricated;

FIG. 8 is an elevational view of an arrangement that is an alternate to that of FIGS. 4 and 6;

FIG. 9 is an elevational view of portions of a system that is an alternate to that of FIG. 1; and

FIG. 10 is an elevational view of an ice sculpture made with one of the foregoing systems, and employing a balloon for forming a cavity.

### DETAILED DESCRIPTION

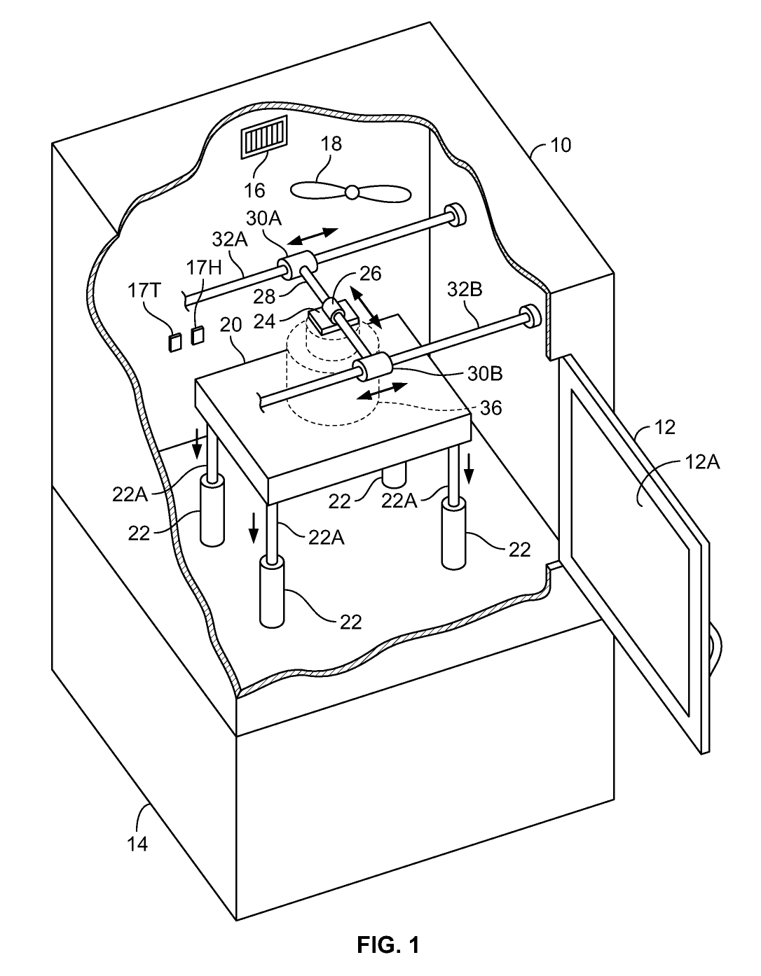

Referring to FIG. 1, the illustrated system includes enclosure 10, a box-like, thermally insulated structure with a door 12 that has an observation window 12A. Enclosure 10 sits atop refrigeration unit 14 which cools the enclosure by means of conduction through the floor of the enclosure, and by convection through port 16, which communicates through a duct (not shown) in the wall of the enclosure to refrigeration unit 14. Mounted inside enclosure 10 are a temperature gauge 17T and a humidity gauge 17H that produce signals signifying the enclosure's temperature and humidity, respectively. Supported from the ceiling of enclosure 10 and driven by a motor (not shown) is a fan blade 18 (free body illustration) for driving cooled air towards a work area that will be discussed presently.

Rectangular platform 20 is supported at its four corners by rods 22A of four actuators 22 that can be operated to adjust the vertical position of the platform. These actuators 22 can be lead screws, pneumatic cylinders, etc. Some alternative embodiments may use instead rack and pinion arrangements, hoist cables, endless belts, and the like. Mechanical power units for adjusting the vertical position of platform 20 can employ stepper motors, servo motors, etc. The corners of platform 20 can be synchronized by mechanically linking the drives for each corner.

Instead of separate actuators at each platform corner, some arrangements may have a single actuator connected to the center of the platform. In this and other cases, the lateral position of the platform 20 can be stabilized by vertical rods that guide the platform.

In FIG. 1 movable print head 24 is shown producing a three-dimensional ice sculpture 36 (shown in phantom) atop platform 20. Print head 24 is supported on movable carrier 26, which is in turn supported on actuator rod 28 The two ends of actuator rod 28 are supported on movable carriers 30A and 30B, which are in turn supported on actuator rods 32A and 32B, respectively. Actuator rods 32A and 32B are supported on opposing inside walls of enclosure 10.

Carrier 26 and actuator rod 28 together act as a linear actuator. Actuator rod 28 may have an outer sleeve that does not rotate axially, and inside the sleeve, an axially rotating lead screw Carrier 26 may act as a lead nut to the lead screw in rod 28. The nonrotating outer sleeve of rod 28 may cooperate with guide rails (not shown) to prevent rotation of carrier 26. Carrier 26 will have threads or other projections that will engage and be longitudinally propelled by the lead screw of rod 28, which lead screw will be rotated by an internal motor (not shown) that is controlled by a controller that will be described presently. Instead of a lead screw, in some embodiments actuator rod 28 may employ pneumatic cylinders, rack and pinion arrangements, cables, endless belts, etc.

Carrier 30A and actuator rod 32A together act as a linear actuator, as do carrier 30B and actuator rod 32B. Linear actuator 30A/32A will be synchronized to linear actuator 30B/32B by having a common mechanical drive and/or a common electronic controller. Rod 32A (32B) may have an outer sleeve that does not rotate axially, and inside the sleeve, an axially rotating lead screw. Carrier 30A (30B) may act as a lead nut to the lead screw in rod 32A (32B). The linkage of actuator rod 28 to carriers 30A and 30B will prevent their rotation. Carrier 30A (30B) will have threads or other projections that will engage and be longitudinally propelled by the lead screw of rod 32A (32B), which lead screw will be rotated by an internal motor (not shown) that is controlled by a controller that will be described presently. Instead of a lead screw, for some embodiments actuator rod 32A (32B) may employ pneumatic cylinders, rack and pinion arrangements, cables, endless belts, etc.

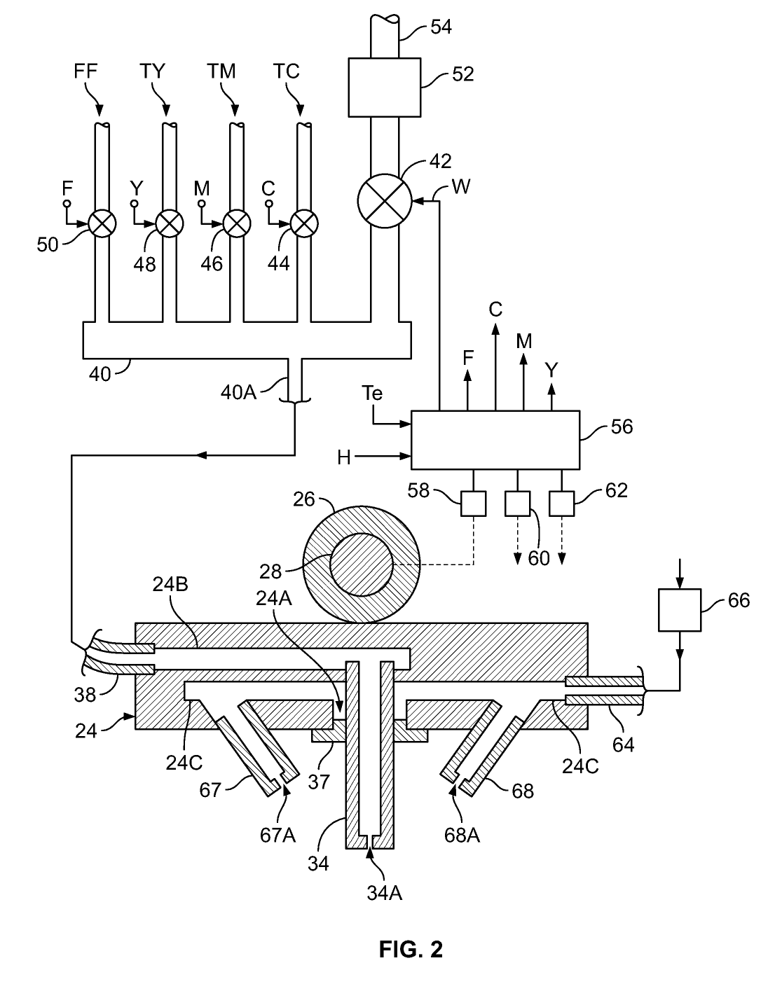

Referring to FIG. 2, print head 24 is shown as a rectangular metal block with a tubular spray nozzle 34 that is held in place in oversized bore 24A by collet 37. Nozzle 34 has an aperture 34A on its distal end. Bore 24B communicates with the proximal end of nozzle 34. The outside end of bore 24B is an inlet that connects to one end of flexible conduit 38, whose other end connects to outlet 40A of manifold 40 Manifold 40 is shown with five fluid inlets that are fed through electromechanical valves 42, 44, 46, 48, and 50, which are controlled by inputs W, C, M, Y, and F, respectively

A source of chilled water is supplied to valve 42 from cooling unit 52, which receives water from supply line 54. In some cases the water from unit 52 may be supercooled. The flow rate of chilled water through valve 42 is controlled by the signal on input W, which signal is provided by programmed microcontroller 56 in this embodiment. The signal on input W can control water flow rate over a continuous range from zero (no water flow) to a maximum water flow rate (valve fully open). Controller 56 has an inputs Te and H receiving signals from temperature sensor 17T and humidity sensor 17H, respectively, (FIG. 1) for regulating the printing process in a manner to be described presently.

In some embodiments a viscosity enhancing agent will be added to the chilled water from supply line 54. As described hereinafter, the enhanced viscosity will retard the spreading of deposited water to increase the accuracy of deposition and prevent spilling of the deposited water. In some embodiments the viscosity enhancing agent may be carboxymethyl cellulose or methyl cellulose.

Outputs C, M, and Y of controller 56 connect to the correspondingly marked inputs on valves 44, 46, and 48, respectively. Valves 44, 46, and 48 are fed cyan dye TC, magenta dye TM, and yellow dye TY, respectively The flow rate of dyes through valves 44, 46, and 48 is controlled by the signals on their respective inputs C, M, and Y, which signals are provided by the correspondingly marked outputs of controller 56 The signals on inputs C, M, and Y can control dye flow rate over a continuous range from zero (no flow) to a maximum flow rate (valve fully open). Accordingly, a mixture of water and dyes can be supplied from manifold 40 through conduit 38 to the inlet of bore 24B, which inlet may be considered a connection for water and for dye.

Controller 56 transmits a control signal to output device 58, which mechanically controls actuator rod 28, as represented by the dotted line connecting between rod 28 and output device 58. It will be understood that in this Figure, rod 28 and carrier 26 are diagrams serving merely to schematically illustrate the presence of an actuator that is, in practice, more complex. As previously mentioned, actuator rod 28 may be a lead screw, while carrier 26 may be a nut that is longitudinally driven by rod 28 without axially rotating.

Controller 56 also transmits a control signal to output device 60, which mechanically controls actuator rods 32A and 32B (FIG. 1), in a manner similar to output device 58. In a similar fashion, controller 56 transmits a control signal to output device 62, which controls actuators 22 (FIG. 1). Output devices 58, 60, and 62 can continuously adjust the linear position of their respective actuators over a predetermined range.

Fluent fibrous material FF is fed to valve 50, which is controlled by the signal on input F originating as an identically marked output from controller 56. Material FF may be a liquid that carries a dispersed fibrous material, such as cellulosic or polymeric strands Again, valve 50 can be regulated by controller 56 to provide a continuously adjustable flow rate over a predetermined range (zero to a maximum flow rate).

Bore 24C intersects oversized bore 24A and connects on its outside end to flexible conduit 64, which is connected to a source of fluid 66. In this embodiment source 66 is a refrigeration unit that supplies frigid air through conduit 64 to bore 24C. In other embodiments source 66 may be a supply of a liquefied gas such as liquid nitrogen.

Ducts 67 and 68 are mounted in slanted bores on the underside of print head 24 and are set at converging angles relative to spray nozzle 34. Ducts 67 and 68 (also referred to as ports) communicate with bore 24C. The distal ends of ducts 67 and 68 have nozzles 67A and 68A in the form of relatively small apertures. The small apertures may be useful when discharging a liquefied gas that will then become gaseous, but in some embodiments ducts 67 and 68 will not have a constricting outlet in order to promote free flow through the ducts.

To facilitate an understanding of the principles associated with the foregoing apparatus, its operation will be briefly described in connection with the embodiment of FIGS. 1 and 2. Initially, an operator will program controller 56, much like one programs a 3-D printer. For example, the operator can start with a CAD drawing that is converted into a file that specifies the outline of successive layers of the object defined by the CAD drawing. Controller 56 then initializes the system by sending a signal through output device 62 directing actuators 22 to lift platform 20 to a position close to print head 24. Print head 24 will be separated from platform 20 by an amount appropriate to allow for the deposition of ice in a manner to be described presently.

In some embodiments controller 56 will initially move print head 24 in a remote, superfluous pattern simply to allow time to prime the water delivery system, before starting the actual development of the desired ice sculpture. In any event, controller 56 will eventually begin the sculpture by moving print head 24 to a position along the periphery of the sculpture that is about to be developed. Specifically, controller 56 will send a signal through output devices 58 and 60 to move carriers 26 and 30A/30B to the desired start position.

In this case, the desired sculpture 36 will be a coaxial stack of cylinders (much like a tiered wedding cake). Accordingly, print head 24 will move to a position that can be considered the circumference of the base of the lowest cylinder. In a known manner, controller 56 and devices 58 and 60 will move print head 24 in a preprogrammed raster to create the first layer. For example, the raster can first draw the outline of the first layer and later fill the outline by following a zigzag pattern.

While print head 24 is moving, controller 56 will send a signal to input W to open valve 42 Valve 42 will produce a flow rate consistent with the speed of the print head 24 in order produce a uniform density throughout the layer. In addition the temperature and humidity signal on inputs Te and H may be used by controller 56 to adjust the speed of print head 24 and/or the flow rate through valve 42 depending on whether or not the enclosure's temperature and humidity are conducive to rapid freezing. Water chilled by cooling unit 52 will be close to the freezing point or may, in some cases, be supercooled. This water will pass through manifold 40, outlet 40A, conduit 38, bore 24B, and nozzle 34 before being ejected through aperture 34A as a very narrow stream, or as fine water droplets, that land onto platform 20.

Refrigeration unit 14 can keep platform 20 and the air in refrigerated enclosure 10 below the freezing point. The air in enclosure 10 can be circulated by fan 18 to maintain a uniform sub-freezing temperature. In addition, frigid air from refrigeration unit 66 passes through conduit 64 and into bore 24C. This frigid air passes immediately into duct 68, and also passes around oversized bore 24A to duct 67. Frigid air ejected through nozzles 67A and 68A will mingle with and further cool the water from aperture 34A. In some cases liquid nitrogen supplied from unit 66 and ejected through nozzles 67A and 68A will immediately evaporate to produce an extremely low temperature environment

Additionally, the above mentioned viscosity enhancing agent in the water will tend to retard spreading of the deposited water. Thus, the water will tend to stay in place longer, increasing the ability to freeze the water in the desired location more accurately. This feature is particularly helpful for preventing water deposited near the edge of platform 20 from spilling off the platform

All, or even a subset, of the foregoing will result in rapid freezing of the water reaching platform 20. The layer of ice produced in this fashion can be designed to have almost any desired thickness, although good results are achieved with thicknesses in the range of 0.01 to 60 mm. The actual thickness will be chosen depending upon the desired fine detail, production speed, water flow rate, freeze rate, temperature, humidity, etc.

Once the first layer of ice has been deposited on platform 20, controller 56 will send a signal to input W to close valve 42. Controller 56 will also send a signal through output device 62, causing actuators 22 to lower platform 20 an amount equal to the desired layer thickness. Controller 56 may pause at this juncture to allow time for the just deposited layer to freeze. The pause time will be adjusted by controller 56 according the temperature and humidity signal on its inputs Te and H.

Controller 56 will now begin to operate based on the next higher layer defined in the converted file that specifies each layer's outline. Accordingly, print head 24 will move to position that can be considered the circumference of the lowest cylinder of ice sculpture 36. Again, controller 56 will move print head 24 in a preprogrammed raster to create the second layer. Specifically, controller 56 will send a signal to input W to open valve 42. Water will pass through manifold 40, outlet 40A, conduit 38, bore 24B, and nozzle 34 before being ejected through aperture 34A as a very narrow stream, or as fine water droplets, that land onto the layer of ice previously deposited on platform 20. As before, the frigid temperature in enclosure 10 as well as the cold fluid stream from ducts 67 and 68 will freeze the water deposited by aperture 34A.

The foregoing process will be repeated, layer by layer During this process, the lower cylinder of ice sculpture 36 will be completed before the controller 56 begins producing the upper cylinder. This upper cylinder will be produced with an outline defined as a circle with a smaller diameter. When this upper cylinder is finished, the ice sculpture is completed, the water flow ceases, and print head 24 can be withdrawn to a remote home position.

Each of the foregoing layers can be colored in a preprogrammed manner by controller 56. Specifically, controller 56 can open valves 44, 46, and 48 by sending appropriate signals to inputs C, M, and Y, respectively. Valves 44, 46, and 48 can be opened anywhere from 0 to 100% depending upon the desired color. Accordingly, cyan dye TC, magenta dye TM, and yellow dye TY will mix in manifold 40 to produce a preprogrammed color

It will be understood that not all of the layer need be consistently colored and colors can be spatially adjusted to produce a desired affect. For example, the ice sculpture may be made as a cartoon character with a red shirt and blue pants. In some ice sculptures a colored feature can be embedded inside the ice sculpture (e.g. a red heart inside a character's chest). Where a sharp color boundary is desired, print head 24 will move to a remote location and spray water through nozzle 34 to allow time for the dye mixture to either reach the print head, or be expelled in favor of uncolored (or differently colored) water.

Some ice sculptures will be made with slender, fragile features that might easily break off. When producing such fragile features, controller 56 can send a signal to input F of valve 50 to send fluent, fibrous material FF into manifold 40 and out nozzle 34. This fibrous material will be embedded in the fragile feature to reinforce it.

After sculpture 36 is completed, controller 56 will send a signal through output device 62 to fully lower platform 20. An operator can then open door 12 and remove ice sculpture 36 from platform 20 Sculpture 36 can be inspected and minor imperfections that can be fixed with an appropriate sculpting tool, if desired. Also, the surface of ice sculpture 36 can, optionally, be a smoothed by using a hot air gun to temporarily melt a thin surface layer of the sculpture and then allow it to refreeze. Ice sculpture 36 is now ready for display.

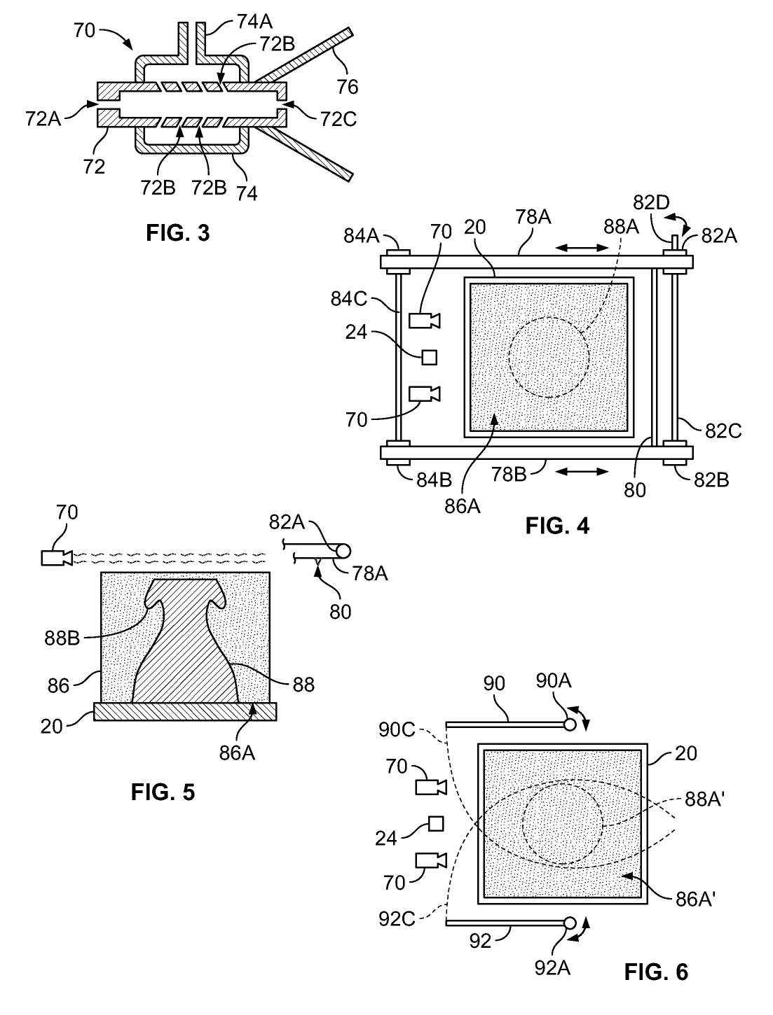

Referring to FIG. 3, a dispensing unit 70 for spraying frozen ice particles has a tubular chamber 72 with an outlet 72C and a water inlet 72A. Unit 70 is also referred to as a sprayer. Annular chamber 74 surrounds tubular chamber 72 and is fed compressed air through inlet 74A Annular chamber 74 communicates with inner chamber 72 through a number of inclined orifices 72B in the wall of inner chamber 72. Outlet 72C of inner chamber 72 is encircled by horn 76. Unit 70 may be built in accordance with the disclosure of U.S. Pat. No. 4,793,554.

In operation, compressed air fed through inlet 74A is injected through orifices 72B into the water in chamber 72 that was supplied through inlet 72A. The pressurized air forcibly injects air and water through outlet 72C to form a stream of water droplets that are entrained in the expelled air. The expelled air experiences a sudden drop in pressure, which causes a rapid drop in temperature. As a result, the entrained water droplets are rapidly frozen into ice particles.

Referring to FIGS. 4 and 5, an optional pair of previously mentioned dispensing units 70 are mounted on one side above previously mentioned platform 20, and between a parallel pair of endless belts 78A and 78B. Blade 80 is connected between the lower run of endless belts 78A and 78B. Belts 78A and 78B turn around drums 82A and 82B, which are connected together by common shaft 82C. On the other end, belts 78A and 78B turn around drums 84A and 84B, which are connected together by common shaft 84C. Shaft 82C and drums 82A and 82B are driven by coaxial drive shaft 82D, which is powered by an external motor (not shown).

Rotation of drums 82A and 82B causes synchronous circulation of endless belts 78A and 78B, and rotation of shaft 84C and drums 84A and 84B. The circulation of endless belts 78A and 78B causes blade 80 to move in a direction transverse to its length As will be described presently, blade 80 functions as a mechanical spreader and is in the form of a bar with a triangular cross-section with an apex pointing downwardly.

Referring to FIGS. 6 and 7, an optional pair of previously mentioned dispensing units 70 are mounted on one side of previously mentioned platform 20. In this embodiment, a pair of mechanical spreaders 90 and 92 are shown as pivotally mounted blades mounted to pivot on hubs 90A and 92A, respectively, and follow respective arcs 90C and 92C.

The operation of these alternate system will now be described in connection with FIGS. 1-5. For this alternate system, a pair of dispensing units 70 (FIGS. 3 and 4) will be placed to one side of platform 20 at the same elevation as print head 24. Again, controller 56 will bring platform 20 to an initial height close to print head 24. Before print head 24 comes into play, controller 56 will start dispensing units 70 to spray a layer of frozen ice particles 86A on platform 20 (FIG. 4). After a predetermined time interval dispensing units will be stopped.

Next, controller 56 will start a motor (not shown) to rotate shafts 82C and circulate belts 78A and 78B in order to move blade 80 from the retracted position shown in FIG. 4. Blade 80 will then move across layer 86A smoothing it and establishing a uniform height, which height will be substantially the layer height previously described for individual layers of the ice sculpture. Thereafter belts 78A and 78B will reverse direction to bring blade 80 back to the original retracted position

Now, print head 24 will move to a position that can be considered the base of the sculpture. The base of the sculpture is shown in phantom as outline 88A in FIG. 4. Controller 56 will move print head 24 in a preprogrammed raster to deposit water inside outline 88A in order to begin fabrication of the first layer of the desired sculpture. The deposited water will rapidly freeze for the reasons previously described. Accordingly, the layer inside outline 88A will become a solid layer of ice.

The foregoing process will now be repeated layer by layer. Specifically successive layers of fresh ice particles will be deposited by units 70 atop growing ice sculpture 88, as shown in FIG. 5. Again, each fresh layer will be leveled to a predetermined height by blade 80, before print head 24 is employed to produce a layer of ice within a subsection of the layer of frozen ice particles.

Also as before, controller 56 can operate valves 46-52 to add fibrous material FF or dyes TC, TM, and TY.

As shown in FIG. 5, the growing ice sculpture 88 is an axially symmetric figure with an overhanging feature 88B bordering an annular undercut. It will be appreciated that such a feature would begin as a ring unconnected to the main body of the sculpture 88, and could not be created without some underlying support that would allow the feature to grow and eventually connect to the main body of the sculpture.

Sculpture 88 is shown in FIG. 5 buried up to its topside by a continuous casing of ice particles 86 This casing of ice particles 86 was formed from the multiple layers of frozen ice particles that were produced by units 70, but were never solidified by water sprayed from print head 24. Casing 86 will be seen as having provided underlying support for feature 88B, before that feature connected to the main body of sculpture 88.

In some embodiments, the mechanical spreader or spreaders can include spreaders to level the top and spreaders to shape the sides of the deposited ice particles. Alternatively, the print head can deposit a thin line of water at the extreme edge of the pile of ice particles to create a thin shell for holding the particles in place as the sculpture is built layer by layer.

The foregoing process will be continued, layer by layer, until the ice sculpture 88 is completed Blade 80 and print head 24 will then be retracted, and platform 20 can be lowered to provide clearance above the sculpture 88.

While sculpture 88 is still resting on platform 20 (or in some cases after the sculpture has been removed from enclosure 10) the loose ice particles of casing 86 can be removed with a brush and/or an air blaster. As before, the sculpture 88 can be detailed with manual sculpting tools, followed by an application of hot air to smooth the surface of the sculpture.

The alternative system of FIGS. 6 and 7 operate in a manner similar to the system shown in FIGS. 4 and 5, except that the initial layer 86A′ (and all subsequent layers) of frozen ice particles deposited by units 70 are leveled by wiper blades 90 and 92. The tips of blades 90 and 92 follow the tracks 90C and 92C and sweep across the entire surface of the deposited ice particles As before, sculpture 88′ has an undercut, overhanging feature 88B′ supported by a casing 86′ of loose ice particles.

Again, the process will be conducted, layer by layer, until ice sculpture 88′ is completed. Print head 24 and blades 90 and 92 will then be retracted, and platform 20 can be lowered to provide clearance above the sculpture 88′. Thereafter, the loose ice particles of casing 86′ can be removed with a brush and/or an air blaster. As before, the sculpture 88′ can be detailed with manual sculpting tools, followed by an application of hot air to smooth the surface of the sculpture.

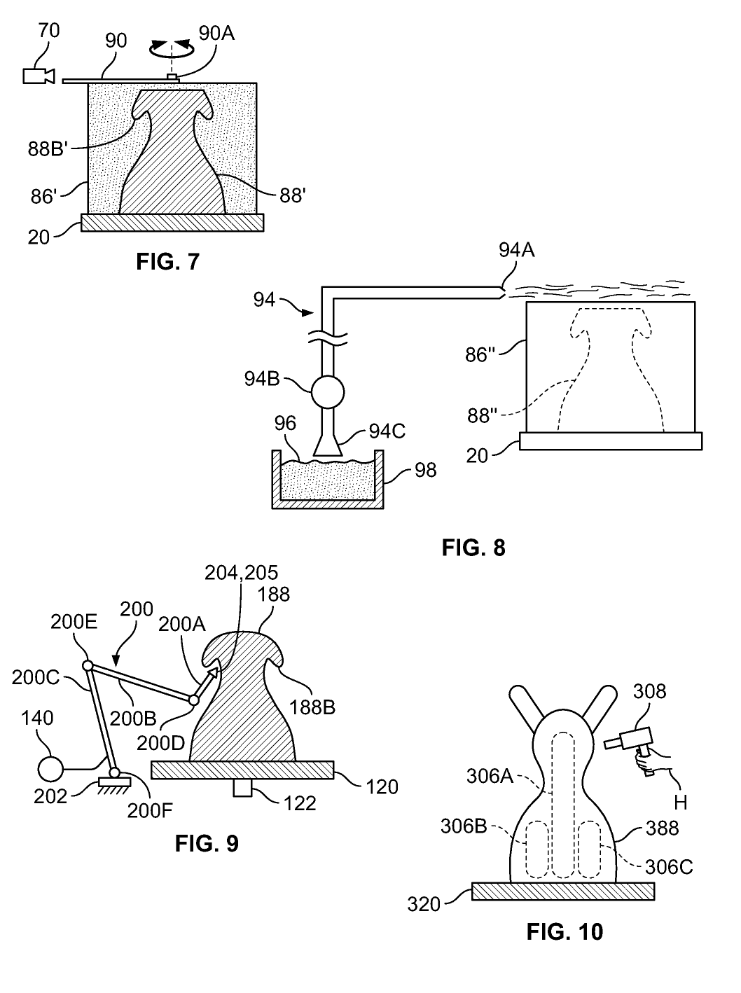

Referring to FIG. 8, the illustrated dispensing unit 94 is an alternate to that of FIG. 3. Specifically, vacuum unit 94B draws from a funnel-shaped head 94C that can suck snow 96 from container 98. Snow 96 can be made naturally or artificially. The vacuumed snow can be discharged by pump 94B through nozzle 94A to spray frozen ice particles across the top of a sculpture 88″ as it is being built.

In the manner previously described, sculpture 88″ can be encompassed by a casing 86″ of frozen ice particles that temporarily support the sculpture. As before, a print head similar to those previously illustrated, may be used to deposit water into the frozen ice particles to convert regions of the ice particles into solid ice.

Referring to FIG. 9, an alternate system is shown, operating with a platform 120 whose height is vertically adjustable by a single column 122, which can be actuated by a hydraulic cylinder, rack and pinion gear, or other actuator.

In this embodiment, print head 204 is supported on the multi-jointed articulated arm 200. Specifically, print head 204 is mounted on the tip of distal limb 200A of articulated arm 200. Distal limb 200A is pivotally connected through joint 200D to intermediate limb 200B Intermediate limb 200B is pivotally connected through joint 200E to proximal limb 200C. Proximal limb 200C is pivotally connected through joint 200F to support base 202. Joints 200D, 200E, and 200F are pivoted by separate motors (not shown) that are controlled by the controller 56 through output devices similar to the previously described output devices (output devices 58, 60, and 62 of FIG. 2).

Chilled water and optional dye can be supplied to print head 204 by manifold 140, which may be similar to the previously described manifold (manifold 40 of FIG. 2). The supplied water can be fed to print head 204 through tubes (not shown) carried by limbs 200A-200C. Print head 204 will be essentially a duct similar to nozzle 34 of FIG. 2, although some embodiments may include cooling ducts (e.g. ducts 67 and 68 of FIG. 2). As before, liquid sprayed from print head 204 will immediately freeze onto ice sculpture 188 after being deposited.

Articulated arm 200 has the ability to reach arbitrary regions of ice sculpture 188 without necessarily progressing from bottom to top. In FIG. 9 print head 204 is shown being inserted from below into the undercut formed by overhang 188B, thereby eliminating the need for a temporary support material when fabricating the overhang.

In some embodiments, opposite sides of ice sculpture 188 can be accessed by articulated arm 200 by rotating column 122, causing platform 120 rotate like a turntable. In other embodiments, base 202 can be mounted on a circular track that can bring articulated arm 200 to different sides of ice sculpture 188. In still other embodiments, articulated arm 200 can be one of a group of articulated arms that are stationed around ice sculpture 188 and operated to simultaneously fabricate the sculpture.

In more complicated embodiments joints 200D-200F can pivot about two axes (i.e., two angular degrees of freedom like the metacarpophalangeal joint), or about three axes (i.e., three angular degrees of freedom like the hip joint, flexion, rotation, and abduction/adduction), these more complicated joints the articulated arm 200 can reach anywhere around sculpture 188 while base 202 remains stationary.

In this embodiment, articulation of limbs 200A-200C at joints 200D-200F can be accomplished with servomotors (not shown) that are controlled by a controller such as the one described previously (controller 56 of FIG. 2). Also in this embodiment, a differential GPS receiver 205 acting as a position detector is mounted on print head 204 to provide feedback on the actual position of the print head to a controller. This feedback may be used by the controller to regulate the activity of the print head (head position, spray volume, etc.). In addition, shaft encoders (not shown) at joints 200D-200F can function as position detectors that provide feedback to a controller to increase the position accuracy. Various other position detectors are contemplated for providing feedback on the position of print head 204. For example, position can be monitored by ultrasonic measuring devices, cameras working with pattern recognition software, or working with targets or lights on print head 204. In some cases the position may be determined by laser ranging equipment, scanners working with visible light, Doppler radar detectors, laser distance sensors, infrared distance sensors, etc.

Referring to FIG. 10, ice sculpture 388 has been fabricated using the foregoing equipment. In this case however, a trio of balloons 306A, 306B, and 306C have been pre-positioned as a group before beginning fabrication of the ice sculpture 388.

Balloons 306A, 306B, and 306C can be initially held in place by being taped or glued together as a group Alternatively, they can be initially suspended by strings that are later cut and discarded,. Balloons 306A, 306B, and 306C can also be prematurely withdrawn and discarded before they are completely encased by ice sculpture 388.

The use of balloons 306A, 306B, and 306C creates voids in ice sculpture 388 that reduce the amount of water and ice required and consequently reduces the fabrication time for the ice sculpture.

In FIG. 10 heat gun 308 is shown being held by hand H, which is pointing a stream of hot air against ice sculpture 388 while positioned on base 320 in order to momentarily melt its surface and thereby smooth the sculpture.

It is appreciated that various modifications may be implemented with respect to the above described embodiments. The foregoing systems can be scaled to make miniature sculptures (e.g., 4 to 10 cm tall), very large sculptures (1 to 10 m tall), or some size in between. The outline of the platform supporting the sculpture can be rectangular, circular, oval, polygonal, or other arbitrary outlines. Instead of vertically adjusting the platform supporting the sculpture, some embodiments may vertically adjust the height of the print head. Instead of a block supporting tubular ducts, the print head may be a movable bundle of discrete ducts or nozzles (or a single duct or nozzle). In some embodiments the manifold will be replaced with separate conduits that discharge directly at the print head The refrigeration unit servicing the enclosure can be located at a distance from the enclosure, in some cases. If operating in naturally frigid outdoor environments (or where freezing is enhanced by liquid nitrogen and the like), the enclosure and the refrigeration unit can be eliminated. In some cases the pair of pivoting spreaders can be replaced with a single large pivoting spreader, or with three of more pivoting spreaders. Instead of horizontally spraying ice particles, the particles can be sprayed at a different angle, including vertically.

Obviously, many modifications and variations of the present invention are possible in light of the above teachings. It is therefore to be understood that within the scope of the appended claims, the invention may be practiced otherwise than as specifically described.

1. A system for making a three dimensional ice sculpture, comprising:
an enclosure;
a movable print head mounted in the enclosure for spraying at least water, the print head having an inlet adapted to connect to a source of chilled water;
a controller operable to move the print head and regulate water flow out of the print head; and
a port adapted to be connected to a source of fluid for discharging fluid within the enclosure at a temperature that accommodates ice formation from water sprayed from the print head.

2. A system according to claim 1 wherein the port includes a duct mounted on the print head, the duct being adapted to be connected to the source of fluid and oriented to direct fluid flow into water sprayed from the print head.

3. A system according to claim 2 wherein the duct has a nozzle for discharging fluid at a reduced pressure.

4. A system according to claim 3 wherein the source of fluid is liquefied gas, the nozzle being operable to allow discharged liquefied gas to become gaseous.

5. A system according to claim 1 comprising:
a refrigeration unit for reducing the temperature inside the enclosure.

6. A system according to claim 5 wherein the refrigeration unit is coupled to the port.

7. A system according to claim 5 comprising:
a fan inside the enclosure.

8. A system according to claim 1 comprising:
a vertically movable platform mounted inside the enclosure, the controller being coupled to the platform and operable to control its descent, the controller being operable to move the print head in two dimensions over the platform.

9. A system according to claim 1 comprising:
a platform mounted inside the enclosure, the controller being operable to move the print head in three dimensions over the platform.

10. A system according to claim 9 wherein the print head comprises:
an articulated arm supporting the print head, the controller being operable to articulate the arm and move the print head.

11. A system according to claim 10 wherein the arm has a plurality of joints.

12. A system according to claim 1 wherein the chilled water is supercooled.

13. A system according to claim 1 wherein the print head has a connection for receiving at least one dye.

14. A system according to claim 1 comprising:
a manifold adapted to receive chilled water and one or more dyes, the controller being operable to control the flow of the chilled water and one or more dyes, the inlet of the print head being coupled to the manifold to receive its contents.

15. A system according to claim 14 wherein the manifold is adapted to receive fluent fibrous material for delivery to the inlet of the print head.

16. A system according to claim 14 wherein the chilled water has a viscosity enhancing agent to retard spreading of the chilled water discharged from the print head into the sculpture.

17. A system according to claim 1 comprising:
a temperature sensor mounted in the enclosure and coupled to the controller for measuring temperature in the enclosure to allow the controller to adjust activity at the print head in response to the temperature sensor.

18. A system according to claim 17 comprising:
a humidity sensor mounted in the enclosure and coupled to the controller for measuring humidity in the enclosure to allow the control to adjust activity at the print head in response to the humidity sensor.

19. A system according to claim 1 comprising:
a position detector for monitoring movement of the print head and feeding back positional information to the controller.

20. A system according to claim 19 wherein said position detector is a GPS receiver mounted on the print head.

21. A system according to claim 1 comprising:
a platform; and
a dispensing unit for delivering frozen ice particles at the platform.

22. A system according to claim 21 wherein the dispensing unit comprises a sprayer for discharging a mixture of water droplets and air.

23. A system according to claim 21 wherein the dispensing unit comprises:
a container adapted to hold a supply of snow; and
a vacuum unit for drawing snow from the container and delivering the snow at the platform.

24. A system according to claim 21 comprising:
a mechanical spreader for evenly redistributing the frozen ice particles delivered at the platform.

25. A system according to claim 24 wherein the spreader comprises:
a blade mounted to move in a direction transverse to its length.

26. A system according to claim 24 wherein the spreader comprises:
a pivotally mounted blade.

27. A system according to claim 21 comprising:
a balloon supported on the platform

28. A system for making a three dimensional ice sculpture, comprising:
a refrigerated enclosure;
a movable print head mounted in the enclosure for spraying at least water, the print head having an inlet;
a controller operable to move the print head and regulate water flow out of the print head;
a duct mounted on the print head, the duct being adapted to be connected to a source of fluid and oriented to direct fluid flow into water sprayed from the print head;
a fan inside the enclosure;
a vertically movable platform mounted inside the enclosure, the controller being coupled to the platform and operable to control its descent, the controller being operable to move the print head in two dimensions over the platform; and
a manifold adapted to receive chilled water and one or more dyes, the inlet of the print head being coupled to the manifold to receive its contents.

29. A system according to claim 28 comprising:
a dispensing unit for delivering frozen ice particles at the platform; and
a mechanical spreader for evenly redistributing the frozen ice particles delivered at the platform.

30. A method employing a platform inside an enclosure for making a three dimensional ice sculpture, the method comprising the steps of:
initially spraying at least water at a time-varying location above the platform to form a base layer that is allowed to freeze; and
subsequently spraying at least water at a time-varying location above the base layer to form a succeeding layer that is allowed to freeze.

31. A method according to claim 30 comprising the step of:
discharging fluid within the enclosure at a temperature that accommodates ice formation from water initially sprayed and subsequently sprayed.

32. A method according to claim 31 wherein the step of discharging fluid is performed by directing fluid into moving water that is initially and subsequently sprayed

33. A method according to claim 30 comprising the steps of:
initially delivering frozen ices particles at the platform before the step of initially spraying at least water, the step of initially spraying being performed over less than or equal to all of the initially delivered ice particles;
subsequently delivering frozen ice particles at the platform between the steps of initially and subsequently spraying at least water, the step of subsequently spraying being performed over less than or equal to all of the subsequently delivered ice particles; and
removing frozen ices particle that were initially and subsequently delivered but were not sprayed with at least water during the step of initially and subsequently spraying.
